(19) United States
(12) Patent Application Publication
(10) Pub. No.: US 2011/0136089 A1
(43) Pub. Date: Jun. 9, 2011

(54) MULTIPLE TARGETS, PHYSICAL ABILITY ENHANCER APPARATUS

(76) Inventor: Jesse Jamison Hansen, Loveland, CO (US)

(21) Appl. No.: 12/960,217

(22) Filed: Dec. 3, 2010

Related U.S. Application Data
(62) Division of application No. 12/565,738, filed on Sep. 23, 2009, now abandoned.
(60) Provisional application No. 61/192,941, filed on Sep. 23, 2008.

(51) Int. Cl. G09B 19/00

(52) U.S. Cl. 434/258

(57) ABSTRACT

Disclosed is an exercise apparatus and method for using the exercise apparatus to improve hand-eye coordination, body coordination, and peripheral vision. The exercise apparatus has a horizontal member placed parallel to a floor and above a user. There are a plurality of target objects tethered to said horizontal member via a tether from each target object to the horizontal member. The plurality of target objects hang down from the horizontal member and are spaced along the horizontal member with enough space between tethers to permit each of said plurality of target objects to swing independently from rest of the target objects. To enhance a user's physical abilities, the user sets at least two of the target objects in motion and keeps the target objects in motion by hitting the target objects appropriately. The user may also avoid the moving target objects by moving the user's body appropriately. The user may remain standing/sitting in one place while keeping the target objects moving and avoiding being hit by the target objects, and/or the user may move around the target objects while performing the exercises.

### CROSS REFERENCE TO RELATED APPLICATIONS

This application is a divisional application of U.S. application Ser. No. 12/565,738, filed Sep. 23, 2009, entitled “Multiple Targets, Physical Ability Enhancer Apparatus,” which application is based upon and claims priority to U.S. provisional application Ser. No. 61/192,941, filed Sep. 23, 2008, entitled “Multiple Targets, Physical Ability Enhancer Apparatus,” by Jesse Jamison Hansen, all of which is specifically incorporated herein by reference for all that it discloses and teaches.

### BACKGROUND OF THE INVENTION

Hand-eye coordination and overall body coordination are important skills for many human endeavors. In particular, hand-eye and body coordination are important to most, if not all, athletic activities. For instance, a baseball player needs to judge the travel of the ball using and then catch the ball in the glove/hand, thus requiring hand-eye coordination. The baseball player may further be required to run to the location where the ball is traveling and to adjust the body to permit the player to catch the ball, requiring overall body coordination. Also, the baseball player may need to maintain a consciousness of outside factors such as the wall or other players in the baseball player's peripheral vision in order to avoid unnecessary and/or potentially painful contact with the outside factors. As is understood by those skilled in the art, other sports share similar issues with hand-eye and body coordination combined with maintaining a consciousness of outside factors using peripheral vision. Further, tasks at work or home may also require hand-eye and body coordination with the management of outside factors using peripheral vision.

Numerous exercise/training devices and methods have been created to assist athletes and workers in training and improving performance of a task or sport. In some cases, stationary objects are used to assist an athlete/person in training for a sport/task. For instance, an athlete training for tennis or baseball may hit a ball against a stationary wall. Other training apparatus may be moved by the athlete/person, such as a football player blocking a tackling dummy attached to a sled to practice blocking techniques. For sports that require hitting a ball, such as baseball and tennis, a single ball suspended by a tether has been used as a means to perfect the stroke, power and placement of a bat/racket in hitting the tethered ball, with the tether permitting the athlete/person to hit a ball suspended in the air and with the tether keeping the ball from traveling away from the user such that the user may repeatedly hit the ball without the need to retrieve the ball. Boxing has provided a single swinging punching bag to assist a boxer with punch placement and power. A smaller, single “speed bag” (a small punching bag that rebounds back toward the user when punched) is also used by boxers to improve a boxer's punching speed and accuracy.

### SUMMARY OF THE INVENTION

An embodiment of the present invention may comprise an exercise apparatus for improving hand-eye coordination, overall body coordination, and/or peripheral vision comprising: a horizontal member disposed substantially parallel to a floor; a plurality of target objects, each target object of the plurality of target objects tethered to the horizontal member by a tether that permits each target object of the plurality of target objects to swing from the horizontal member by the tether, each tether of each target object of the plurality of target objects spaced along a length of the horizontal member so as to provide sufficient space between each target object of the plurality of target objects to swing substantially independently of other target objects of the plurality of target objects; and an elevation assembly to hold the horizontal member above a user such that the target objects hang down from above the user for use in performing exercises to improve coordination and/or peripheral vision.

An embodiment of the present invention may further comprise a method for using an exercise apparatus, the exercise apparatus comprising a horizontal member placed parallel to a floor, above a user, and having a plurality of target objects tethered to the horizontal member via a tether with the plurality of target objects hanging down from the horizontal member and spaced along the horizontal member to permit each of the plurality of target objects to swing independently from a remainder of the plurality of target objects, the method comprising: placing a user within a proximity of the exercise apparatus such that the plurality of target objects, when set in motion, are within range of the tether of hitting the user unless the user hits or avoids the plurality of targets; setting at least a first target object of the plurality of targets into motion; keeping the at least first target object in motion by the user; setting at least a second target object of the plurality of targets into motion while the at least first target is in motion; and concurrently keeping the at least first target object and the at least second target object in motion by the user, such that the user keeping the at least first target object and the at least second target object in motion is intended to improve coordination and/or peripheral vision of the user.

### BRIEF DESCRIPTION OF THE DRAWINGS

In the drawings,

FIG. 1A is a schematic illustration of a front view of a basic embodiment of a multiple target physical enhancer exercise apparatus.

FIG. 1B is a schematic illustration of a side view of a basic embodiment of a multiple target physical enhancer exercise apparatus.

FIG. 1C is a schematic illustration of a top view of a basic embodiment of a multiple target physical enhancer exercise apparatus.

FIG. 2A is a schematic illustration of a front view of a curved horizontal member embodiment of a multiple target physical enhancer exercise apparatus.

FIG. 2B is a schematic illustration of a side view of a curved horizontal member embodiment of a multiple target physical enhancer exercise apparatus.

FIG. 2C is a schematic illustration of a top view of a curved horizontal member embodiment of a multiple target physical enhancer exercise apparatus.

FIG. 3A is a schematic illustration of a front view of a curved horizontal member with a tether directing assembly embodiment of a multiple target physical enhancer exercise apparatus.

FIG. 3B is a schematic illustration of a side view of a curved horizontal member with a tether directing assembly embodiment of a multiple target physical enhancer exercise apparatus.

FIG. 3C is a schematic illustration of a top view of a curved horizontal member with a tether directing assembly embodiment of a multiple target physical enhancer exercise apparatus.

FIG. 4 is a schematic illustration of a top view of an adjustable eyelet channel embodiment of a multiple target physical enhancer exercise apparatus.

FIG. 5 is a schematic illustration of a bottom view of an adjustable eyelet channel embodiment of a multiple target physical enhancer exercise apparatus.

FIG. 6 is a schematic illustration of a side view of an adjustable eyelet channel embodiment of a multiple target physical enhancer exercise apparatus with a wall mount.

FIG. 7 is a schematic illustration of a side view of an adjustable eyelet channel embodiment of a multiple target physical enhancer exercise apparatus with a ceiling mount.

FIG. 8 is a schematic illustration of a side view of an adjustable eyelet channel embodiment of a multiple target physical enhancer exercise apparatus with a ceiling mount and without a height adjustment tether.

FIG. 9 is a schematic illustration of a side view of an adjustable eyelet channel embodiment of a multiple target physical enhancer exercise apparatus with a ceiling mount and a user adjusting the height of the target objects.

FIG. 10 is a schematic illustration of a front view of an adjustable eyelet channel embodiment of a multiple target physical enhancer exercise apparatus with a ceiling mount.

FIG. 11 is a schematic illustration of a front view of an adjustable eyelet channel embodiment of a multiple target physical enhancer exercise apparatus with a wall mount.

FIG. 12A is a blowup perspective view of an eyelet channel of an adjustable eyelet channel embodiment of a multiple target physical enhancer exercise apparatus.

FIG. 12B is a blowup perspective sectional view of the near half of an eyelet channel of an adjustable eyelet channel embodiment of a multiple target physical enhancer exercise apparatus.

FIG. 12C is a blowup perspective sectional view of the far half of an eyelet channel of an adjustable eyelet channel embodiment of a multiple target physical enhancer exercise apparatus.

FIG. 13 is a blowup perspective sectional view of the far half of an eyelet channel of an adjustable eyelet channel embodiment of a multiple target physical enhancer exercise apparatus being adjusted with an adjustment tool.

FIG. 14A is an illustration of a user using a tool to place a target object on a retaining clip for storage.

FIG. 14B is a blown up illustration of using a tool to place a target object on a retaining clip for storage.

FIG. 15 is a schematic illustration of varying materials for the tether.

FIG. 16 is a schematic illustration of covering the tether with a segmented tubing material.

FIG. 17 is an illustration of a user performing exercises while standing on both legs.

FIG. 18 is an illustration of a user performing exercises while standing on one leg.

FIG. 19 is an illustration of a user performing exercises while standing on one leg and standing on a balance board.

FIG. 20 is an illustration of a user performing exercises while moving in a circular motion around the target objects.

FIG. 21 is an illustration of a user performing exercises while sitting in a wheel chair.

### DETAILED DESCRIPTION OF THE EMBODIMENTS

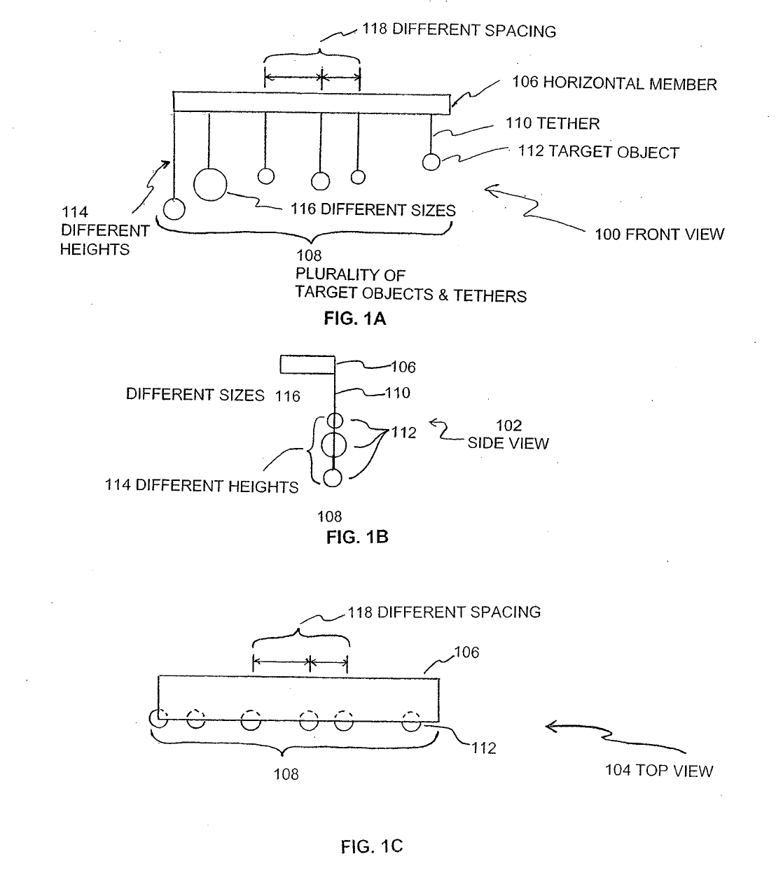

FIGS. 1A-C are schematic illustrations of a front view 100, side view 102, and top view 104 of a basic embodiment of a multiple target physical enhancer exercise apparatus. A basic embodiment of a multiple target physical enhancer exercise apparatus may comprise a horizontal member 106 and a plurality of target objects and tethers 108. Each of the plurality of target objects and tethers 108 is comprised of a target object 112 and a tether 110. The tether 110 tethers/connects the target object 112 to the horizontal member. In use, the horizontal member 106 is placed parallel to the floor/ground and above a user such that the plurality of target objects and tethers 108 hangs down from above the user. Some type of elevation assembly may be necessary to hold the horizontal member 106 above a user. Some types of elevation assemblies that may be used to hold the horizontal member 106 above the head of a user may include, but are not limited to: a screw and bracket assembly to attach the horizontal member 106 to a ceiling; a screw, bracket and extension arm assembly to attach the horizontal member 106 to a wall; a bracket assembly to mount the exercise apparatus in a door frame; and a vertical member and base unit to independently support the horizontal member 106. One skilled in the art will recognize that other elevation assemblies that raise the horizontal member 106 above the head of a user and provide a stable platform for the horizontal member 112, may also be used to elevate the horizontal member 106. The tethers 110 may be adjusted to different lengths such that the target objects are located at different heights 114. The spacing (i.e., location) of the target 112 and tether 110 may vary 118 (i.e., have different spacing) between the various target object 112 and tethers 110 to provide variation in how target objects 112 interact with the user and each other. The target objects 112 may be different sizes 116 to provide variation in how the target objects 112 interact with a user. As shown in the drawings of the various embodiments, the target objects are typically represented as balls (i.e., round objects), but the target objects 112 may be any shape desired by a user or exercise apparatus designer. Showing the target objects 112 as balls is convenient for the purposes of the drawings, as well as because the ball shape is a common and desirable shape for a target object 112 for a real world implementation of the multiple target physical enhancer exercise apparatus described herein.

With the horizontal member 106 placed above a user, the plurality of target objects and tethers 108 hangs down such that the target objects 112 are within a proximity of the user that the target objects 112, if set in motion and as restricted by the tethers 110, are able to touch the user. It may also be beneficial if the user is in close enough proximity to reach out and touch the target objects 112. To obtain the full benefit of the physical enhancement of abilities, particularly the hand-eye and body coordination combined with the enhancement of peripheral vision training, at least two of the target objects 112 should be set in motion in order to ensure that a user must track at least a second target object 112 even while concentrating attention on a first target object 112. A user may set the target objects 112 in motion using any method acceptable to the user, including: the user hits a target object 112; the user raises and releases a target object 112; the user throws a target object 112, a third party causes a target object 112 to be moved, and a mechanical device is used to cause a target object 112 to move. A user may stand still and/or move about while interacting with the multiple target physical enhancement exercise apparatus. Some variations for a user standing still (i.e., remaining stationary) include, but are not limited to: standing, standing on one leg, sitting, sitting in a wheelchair, standing on a balance board, standing on one leg on a balance board, sitting on a Bosu Ball, sitting on an inflatable ball, standing with legs bent in a sitting position, standing on an unstable surface, standing on one leg on an unstable surface, and laying down. A variation of an exercise may include the user moving in a circular motion around the plurality of target objects and tethers 108, either clockwise or counterclockwise as desired by the user.

Once the target objects 112 (at least 2 for best results) are in motion and oscillating, as restricted by the tethers 110, the user may work to keep the target objects 112 in motion. With multiple target objects 112, a challenge for the user is to take action on the balls so that the target objects 112 remain in motion. The user may keep the target objects 112 in motion using similar actions as were used to set the target objects in motion (see above), but the most challenging, and therefore the most beneficial, action is for the user to hit the ball as necessary and with the appropriate force to achieve the movement desired by the user. A typical exercise session may include hitting the target objects 112 with a user's hands to achieve the desire goals, but any body part may be used to hit the target objects 112, including: knees, elbows, legs, feet, arms, torso, and head. Using body parts other than the hands to hit the target objects 112, may be useful to provide additional challenges to a user and/or to improve a particular type of coordination/ability of a user.

Another challenge for the user may be to avoid any target objects 112 that may be swinging towards the user. For a stationary user, it may be necessary the user to move portions of the user's body while standing/sitting in place. For instance a user may duck a swinging target object 112 or lean out of the path of the swinging target object 112. For a moving user (such as the user moving around the plurality of target objects and tethers 108 in a circular motion), a combination of movement out of the path of the swinging target objects as well as ducking or leaning may be called for the user to avoid being hit by the target objects 112. The user may also work to ensure that the target objects 112 do not touch one and other during an exercise lesson. The various methods of keeping the target objects 112 in motion may also be used to keep the target objects 112 from hitting one and other, but, again, hitting the target objects with a part of the body appears to provide the most benefit to the user to improve physical abilities. Another potential challenge is for the user to ensure that the various target objects 112 and tethers 110 in the plurality of target objects and tethers 108 do not become tangled as the target objects 112 and tethers 110 swing from the horizontal member 106. When multiple target objects 112 (i.e., at least two target objects 112) are in motion, the user is able to work on peripheral vision/coordination by both tracking at least one target object 112 as the center of attention while tracking and maintaining the motion of at least a second target object 112. Another variation on the exercise to work on peripheral vision is for the user to stand with the user's back to the swinging plurality of target objects 108 and maintain the motion of the target objects 112 and avoid being hit the target objects 112. To achieve success with the user's back turned to the target objects 112, it is necessary the user to track and manage the target objects 112 with the user's peripheral vision. Other variations of the exercises may include having different heights 114 for the target objects 112, different sizes 116 for the target objects 112, and/or spacing the target objects 112 with different spacing 118. One skilled in the art will recognize that by varying the various adjustable factors, a user may be able to create a myriad of minor exercise variations. Some of the adjustable factors used in the exercise process include, but are not limited to, user location proximity relative to the exercise apparatus, the user's stance relative to the target objects (i.e., sitting, standing, moving around), different heights 114 for the target objects 112, different sizes 116 for the target objects 112, different spacing 118 between target objects 112, and/or the addition or subtraction of target objects 112 to the exercise apparatus.

Various embodiments may incorporate different designs for the horizontal member 106. A particularly useful design for the horizontal member may be to provide a curve/arc to permit the plurality of target objects and tethers 108 to drop down around a user standing on the inside portion of the curve. One skilled in the art will recognize that a wide variety of shapes may be used for the horizontal member 106, as necessary to place the targets 112 in pattern relative to the user as desired by an exercise apparatus designer/user.

Various embodiments may incorporate different objects for the target objects 112. The target objects may vary by size 116, shape, weight, density, hardness, or any other physical trait, as desired by an exercise apparatus designer. In order for the target objects to swing properly, it may be necessary that the target object be enough heavier than the tether 110 to ensure that the target object 112 provides the majority of the momentum for the tether 110 and target object 112 motion so that the target object 112 causes enough tension in the tether 110 that the target object 112 controls the swinging motion and not the tether 110. While different shapes may be used, a round “ball” shape has been found to be a desirable choice. An object made of a semi-rigid rubber ball has been found to be desirable for both weight and feel. A good object choice for a target object 112 is a rubber ball similar to a standard “handball.” A “handball” provides a relatively dense object giving a good weight, the “handball” is stiff, but not uncomfortable for a user, and the “handball” provides a reasonable amount of elastic response without being too elastic. A “racquetball” may also function reasonably well, but the “racquetball” may provide too much elastic bounce in response to being struck/hit by a user for some user's preferences. Foam rubber balls (and other shapes), bean filled balls/shapes, wood balls/shapes, metal balls/shapes are other examples of objects that may be used for target objects 112. Various embodiments may also connect a plurality of target objects to single tether to enhance the difficulty of the exercise in order to permit additional enhancement of physical abilities via use of the multiple target exercise apparatus.

Various embodiments may incorporate different materials for the tethers 110. A desirable material for the tether 110 would be a typical cord, string, rope, or chain. That is material/thing that bends freely and handles tension well (i.e., is relatively inelastic in response to being stretched by a weight). While a rubber band would likely swing reasonably well, a rubber band would likely not work well for the tether 110 as the rubber would stretch too much and may cause the target objects 112 to bounce unnecessarily. However, a rubber band may also provide an additional challenge for a user due to the bounce effect. A nylon cord has been found to be a desirable tether material, but other similar materials may also function equally as well. A person skilled in the art will recognize that most, if not all, cord, string, rope, chain, fishing line, or similar material will work as the tether 110. Further, a rigid material such as a plastic or wood rod may also be used provided a reasonable hinge is used to attach the rigid tether 110 to the horizontal member 106. Tether connections for both a flexible material and a rigid material may be permanently affixed to the horizontal member 106, or the tether connections may be adjustable so that the height and/or location of a tether 110 and target object 112 is movable to various locations along the horizontal member. In some instances, the tether 110 may be directed through a tether guide (such as an eyelet or saw-tooth type guide) without being affixed to the horizontal member.

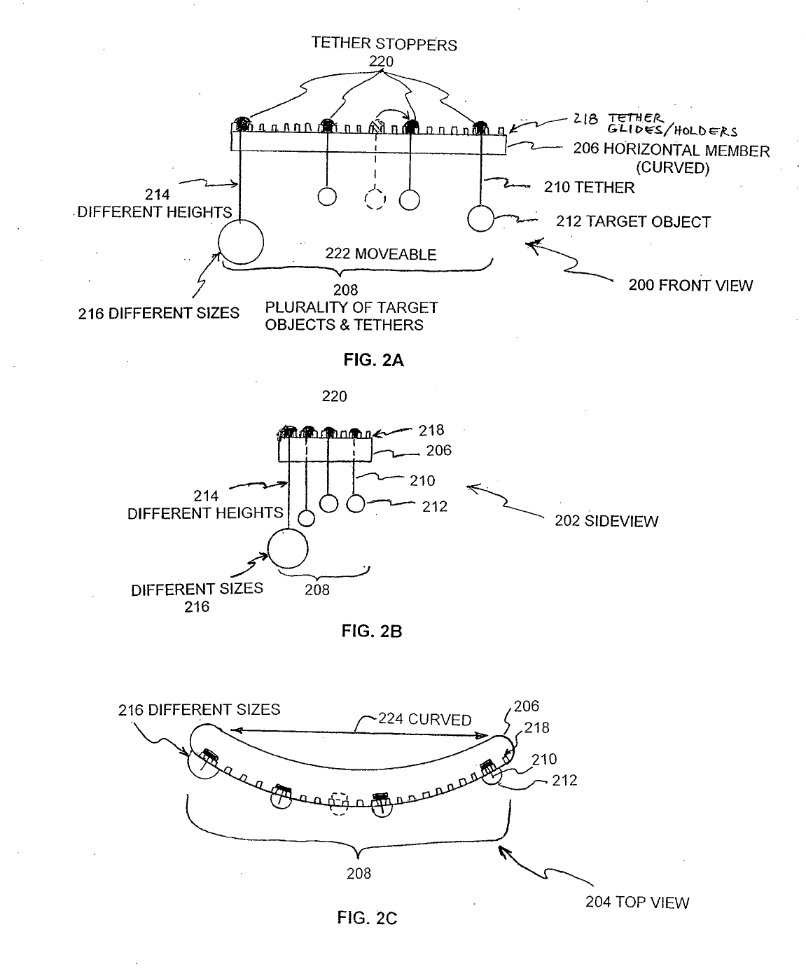

FIGS. 2A-C are schematic illustrations of a front view 200, side view 202, and top view 204 of a curved horizontal member 206 embodiment of a multiple target physical enhancer exercise apparatus. As seen in the top view 204 of FIG. 2C, the horizontal member 206 is curved with a curvature as indicated by 224. The embodiment shown in FIGS. 2A-C also has a series of tether guides/holders 218. The tether guides/holders 218 permit a user to move 222 a tether 210 and target object 212 from one location on the curved horizontal member 206 to a second location on the horizontal member 206. The tether guides/holders 218 also serve to separate the tethers 210 so that the tethers 210 are not attached to each other and drop and move independently of the other tether 210/target objects 212. At the end of the tether 210 connected to the horizontal member 206 is a tether stopper 220 to hold the tether 210 in place in combination with the tether guides/holders 218. The tether stopper 220 is an object large enough that it will not pass through the tether guides/holders 218 attached to the end of the tether 210 opposite from the target object 212. Thus, the tether stopper 220 will be stuck behind the tether guides/holders 218 and support/make the tether connection between the tether 210 and target object 212 and the horizontal member 206. A simple and easy tether stopper may be a not tied in the cord/rope/string comprising the tether 210 such that the knot is sufficiently larger than the space provided for the tether 210 in the tether guides/holders 218 so that the knot in the tether does not pull through the tether guide/holder 218. As noted above, the plurality of target objects and tethers 208, may be comprised of tethers 210 of varying lengths/heights 214, target objects 212 of different sizes 216, and each tether 210/target object 212 may be spaced differently and/or moved entirely 222 by lifting the tether 210, target object 212, and tether stopper 220 to another location along the horizontal member 206. Note that the side view 202 of FIG. 2B shows the plurality of target objects and tethers 208 wrapping around the curved portion 224 of the horizontal member 206 such that the target objects do not obscure each other and that some of the target objects 212 fall on the side facing the viewer and some fall on the side facing away from the viewer.

Various embodiments may incorporate other technology than the tether stopper 220 shown in FIGS. 2A-C to permit individual adjustment of tether 310 length and location on the horizontal member 306. Other potential technology may include, but is not limited to: Velcro, snaps, magnets, buckles, clips, and/or threading as in a nut and bolt.

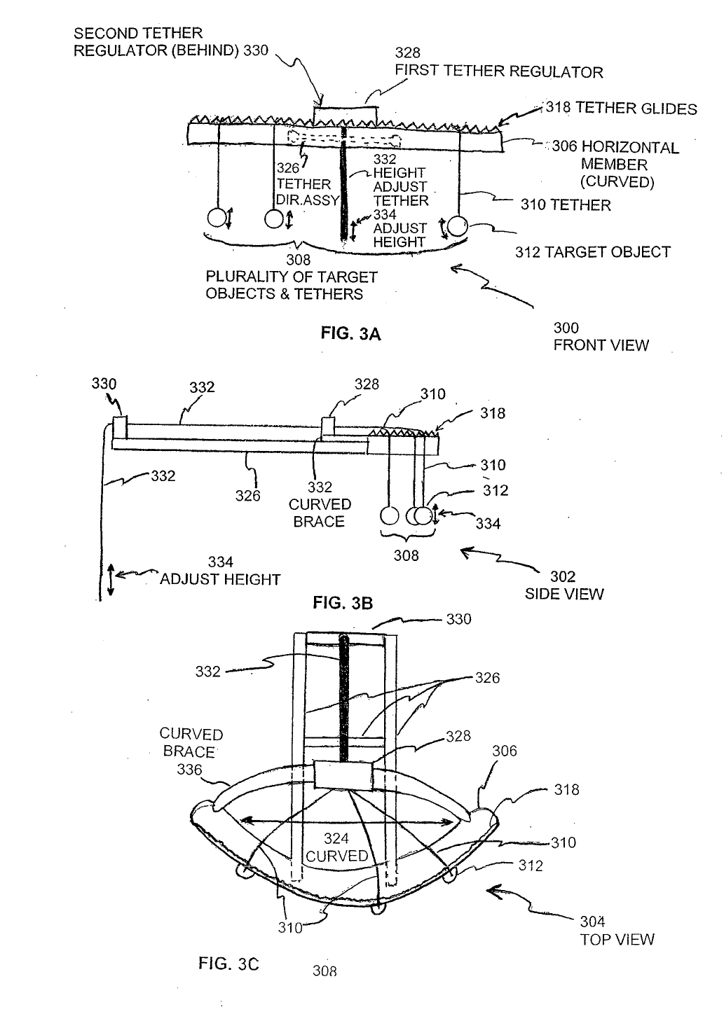

FIGS. 3A-C are schematic illustrations of a front view 300, a side view 302, and a top view 304 of a curved horizontal member 306 with a tether directing assembly 326 embodiment of a multiple target physical enhancer exercise apparatus. In the embodiment shown in FIGS. 3A-C, the tethers 310 of the plurality of target objects and tethers 308 are tethered (connected) to the curved horizontal member 306 by placing the tether 310 over the edge of the horizontal member 306, with the tether 310 fitting into a cavity of the tether guide 318. The tether guide 318 for the embodiment shown in FIGS. 3A-C is a roughly saw-toothed edge where the cavity between teeth of the tether guide 318 holds the tether 310 in on the horizontal member 306 so that the tether does not move back and forth along the length of the horizontal member 306. Various embodiments may implement a tether guide 318 differently than a saw-tooth type of edge. For instance, an embodiment may pass the tethers 310 through eyelets or some other means for guiding the tethers from over/under the horizontal member 306 to the first tether regulator 328. The tethers 310 are connected to a first tether regulator 328 that conjoins the tethers at a single point such that the tether guide 318 may hold the tethers 310 properly in position on the horizontal member 306. The first tether regulator 328 is affixed to the tether directing assembly 326. The tether directing assembly 326 is an assembly placed behind the horizontal member 306 that permits the first tether regulator to conjoin the tethers 310. In order to properly keep the tethers 310 in the desired cavity/slot on the tether guide 318, it is desirable to have the tether directing assembly 326 be parallel to the floor/ground in the same geometric plane as the horizontal member 306 and, within the geometric plane, have the tether directing assembly 326 be perpendicular to the horizontal member 306. In the embodiment shown in FIGS. 3A-C, the tether directing assembly 326 is built of two members extending perpendicular from the horizontal member 306 with some additional cross members connecting across and perpendicular to the two members to add support and rigidity to the tether directing assembly 326. One skilled in the art will recognize that other tether directing assemblies 326 may also perform the necessary task of holding the first tether regulator 328 and directing the tethers 310 to a conjoining point (at the first tether regulator 328).

The first tether regulator provides a conjoining point for the tethers 310 extending from the tether guide 318. The first tether regulator 328 may be as simple as a knot of the individual tethers 310 held in place on the tether directing assembly 326. In a more complex embodiment, the first tether regulator 326 may conjoin the individual tethers 310 into a single tether or group of tethers, which may be referred to as a height adjustment tether 332. If the first regulator 328 directs the height adjustment tether 332 down toward the ground, a user may adjust the height of the plurality of target objects and tethers 308 up and down uniformly 334 for all target objects 312 of the plurality of target objects and tethers 308. That is, each target object 312 of the plurality of target objects and tethers 308 will move up or down 334 the same amount in response to the action on the height adjustment tether 332. Individual target objects 312 may still have a different height relative to one and other by adjusting the length of the tether 310 between the target object 312 and the first tether regulator, but adjustments to the height using the height adjustment tether 332 performs a uniform height adjustment 334 for the plurality of target objects and tethers 308. In order for the first tether regulator 328 to permit height adjustments 334, the first tether regulator necessarily permits the height adjustment tether 332 to slide or otherwise move within the first tether regulator 328.

In the embodiment shown in FIGS. 3A-C, a second tether regulator 330 is affixed to the tether directing assembly 326 at a point further away from the horizontal member than the first tether regulator 328. The second tether regulator 330 is not necessary, but does provide additional space between the horizontal member 306 and the location where the height adjustment tether 332 drops down, which may permit an exercise apparatus where the user stands between the plurality of target objects and tethers 308 and the height adjustment tether 334. Hence, when the user wants to exercise the user may face the plurality of target objects and tethers 308 and when the user wants to adjust the height of the target objects and tethers 308, the user turns around and adjusts the height 334 with the height adjustment tether 332. As with the first tether regulator 328, in order for the height adjustment tether 332 to function properly to adjust the height 334, the second tether regulator necessarily permits the height adjustment tether 332 to slide or otherwise move through the second tether regulator. As shown in FIGS. 3A-C, the first 328 and second 330 tether regulators are simple devices that permit the height adjustment tether 332 to move through the regulators 328, 330 so the target objects 312 move up when the height adjustment tether 332 is pulled down 334 and the target objects 312 move down when the height adjustment tether 332 is permitted to move up 334. One skilled in the art will recognize that a pulley system or other linkage system may be used to change the direction of operation of the height adjustment tether 326 in relation to the height of the target objects 312.

In the embodiment shown in FIGS. 3A-C, a curved brace 336 is also incorporated to add support and rigidity to the horizontal member 306/tether directing assembly 326. The incorporation of the curved brace 336 is not required, but may be desired to enhance the overall strength and stability of the exercise apparatus. As with other embodiments, the embodiment shown in FIGS. 3A-C may be implemented with different size and shape target objects 312, different lengths of the tether 310 from the first tether regulator 328 to the target objects 312 in order to have a different height for target objects 312 relative to one and other, and varied spacing between tethers 310. Further, the embodiment shown in FIGS. 3A-C has two tether regulators 328, 330, but other embodiments with similar functionality may incorporate one, two, or more tether regulators as desired by the exercise apparatus designer. Please note that for the various embodiments, varied or different spacing between the tethers 310 does not preclude a scenario where the spacing is uniform between the tethers. Also note that the side view 302 of FIG. 3B shows the plurality of target objects and tethers 308 wrapping around the curved portion 324 of the horizontal member 306 such that the target objects do not obscure each other and that some of the target objects 312 fall on the side facing the viewer and some fall on the side facing away from the viewer.

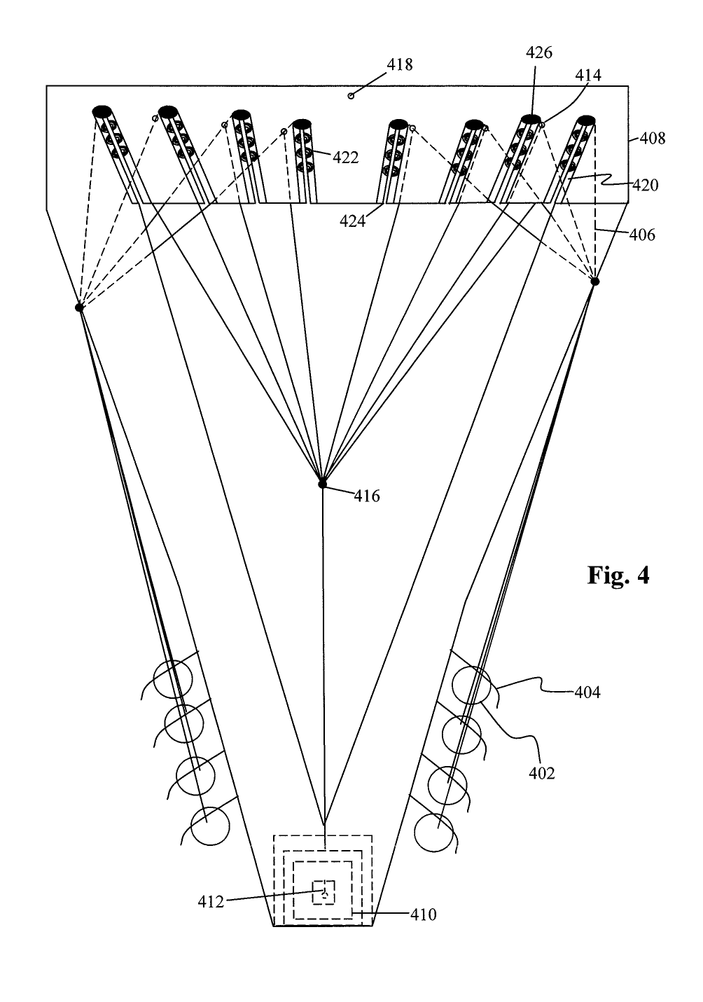

FIG. 4 is a schematic illustration of a top view of an adjustable eyelet channel embodiment of a multiple target physical enhancer exercise apparatus. In the embodiment shown in FIG. 4, the target objects 402 are stored by hanging the target objects 402 on retainer clips 404. The tethers 406 that connect the target object 402 to the horizontal member 408 are attached to eyelets 414, which act as a guide to the location of the target objects 402 when hanging from the horizontal member 408. The eyelets 414 are an assembly made up of an eyelet extension member that is attached to a mass 426. The mass 426 sits in pocket 422 that holds the mass 426 in place. Several eyelet channels 420 are cut into the horizontal member 408. In the bottom of the eyelet channel 420 is a slot 424 cut completely through the horizontal member 408 to permit the eyelet extension connected to the eyelet 414 to extend beneath the horizontal member 408. Each eyelet channel 420 has at least one pocket 422 to hold the mass 426 connected to the eyelet 414 via the eyelet extension. Thus, the location of each eyelet 414 may be adjusted within the eyelet channel 420 on the horizontal member 408. The tethers 3 are linked to the first tether regulator 416 through eyelets 414. The first tether regulator 416, as shown in FIG. 4 is simply a knot conjoining the individual tethers 506 into a single height adjustment tether 412. The height adjustment tether 412 passes through a second tether regulator 410 before being directed down for a user to use the height adjustment tether 412 to adjust the height of the target objects 402. In the embodiment shown in FIG. 4, screw hole 418 may be used to attach the exercise apparatus to a ceiling.

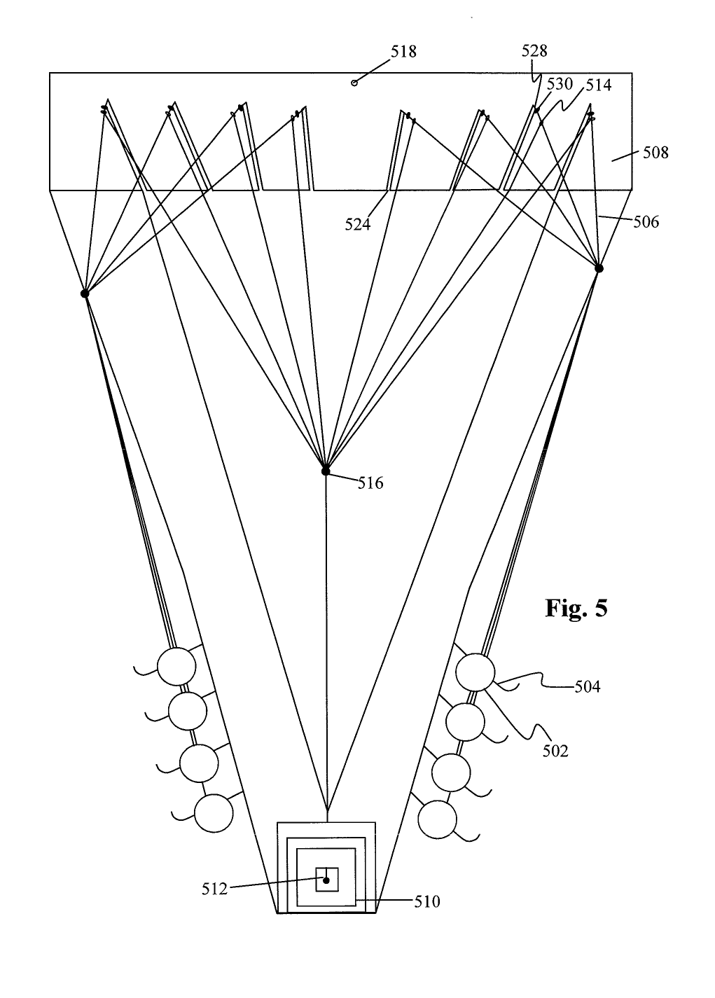

FIG. 5 is a schematic illustration of a bottom view of an adjustable eyelet channel embodiment of a multiple target physical enhancer exercise apparatus. In the embodiment shown in FIG. 5, the target objects 502 are stored by hanging the target objects 502 on retainer clips 504. The tethers 506 that connect the target object 502 to the horizontal member 508 are attached to eyelets 514, which act as a guide to the location of the target objects 502 when hanging from the horizontal member 508. The eyelets 514 are an assembly made up of an eyelet extension member 528 with a retaining eyelet washer 530 that is attached to a mass. As described in the disclosure with respect to FIG. 4, the mass sits in pocket that holds the mass in place. Several eyelet channels are cut into the horizontal member 508. In the bottom of the eyelet channel is a slot 524 cut completely through the horizontal member 508 to permit the eyelet extension 528 connected to the eyelet 514 to extend beneath the horizontal member 508. The tethers 506 are linked to the first tether regulator 516 through eyelets 514. The first tether regulator 516, as shown in FIG. 5 is simply a knot conjoining the individual tethers 506 into a single height adjustment tether 512. The height adjustment tether 512 passes through a second tether regulator 510 before being directed down for a user to use the height adjustment tether 512 to adjust the height of the target objects 502. In the embodiment shown in FIG. 5, screw hole 518 may be used to attach the exercise apparatus to a ceiling.

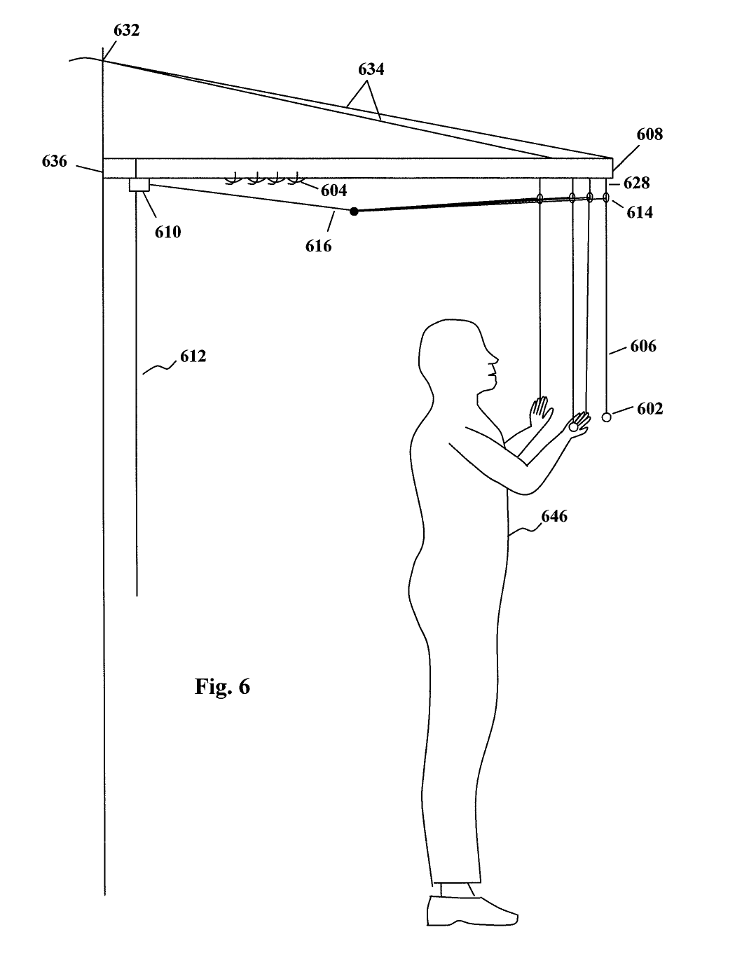

FIG. 6 is a schematic illustration of a side view of an adjustable eyelet channel embodiment of a multiple target physical enhancer exercise apparatus with a wall mount. A user 646 stands beneath the exercise apparatus and interacts with the target objects 602. The target objects 602 are attached to the horizontal member 608 by tethers 606 which are guided by eyelets 614. Eyelets 614 are connected and held in place on the horizontal member 608 by eyelet extension 628 connected to a mass placed in a pocket in an eyelet channel on the horizontal member 608. The tethers 606 are conjoined at a first tether regulator (e.g., a knot) 616. A second tether regulator 610 directs the height adjustment tether 612 from the first 616 and second 610 tether regulators down for easy use by the user 646. When not in use, the target objects 602 may be stored using retainer clips 604. The exercise apparatus is mounted on the wall via wall bracket 636 and additional support of wall suspension members 634 connected to the wall at 632.

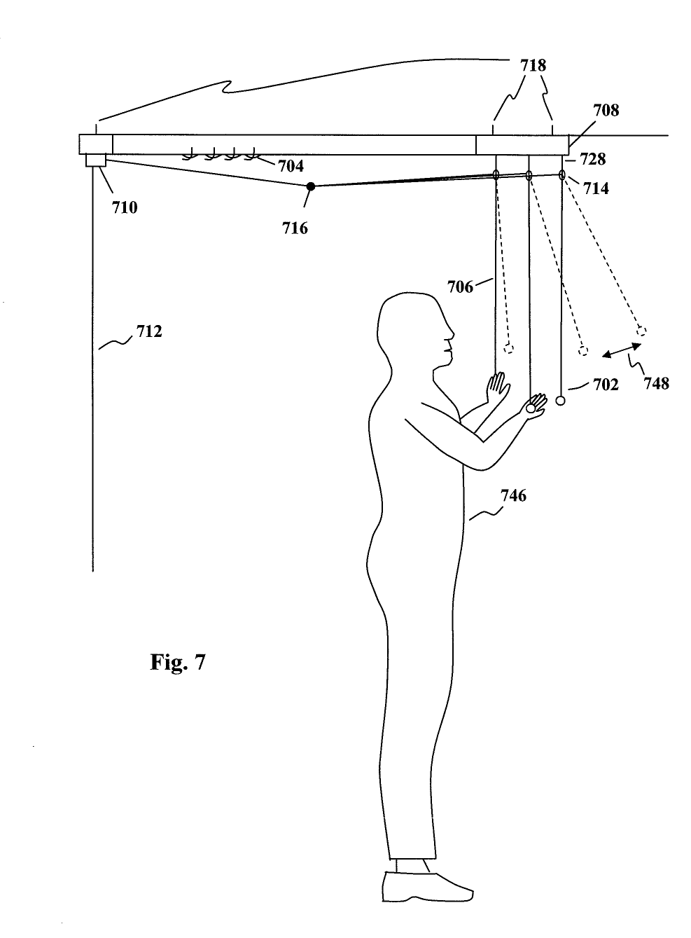

FIG. 7 is a schematic illustration of a side view of an adjustable eyelet channel embodiment of a multiple target physical enhancer exercise apparatus with a ceiling mount. A user 746 stands beneath the exercise apparatus and interacts with the target objects 702. The target objects move and oscillate 748 in response to the actions of the user 746. The target objects 702 are attached to the horizontal member 708 by tethers 706 which are guided by eyelets 714. Eyelets 714 are connected and held in place on the horizontal member 708 by eyelet extension 728 connected to a mass placed in a pocket in an eyelet channel on the horizontal member 708. The tethers 706 are conjoined at a first tether regulator (e.g., a knot) 716. A second tether regulator 710 directs the height adjustment tether 712 from the first 716 and second 710 tether regulators down for easy use by the user 746. When not in use, the target objects 602 may be stored using retainer clips 704. The exercise apparatus is mounted on the ceiling via screws 718.

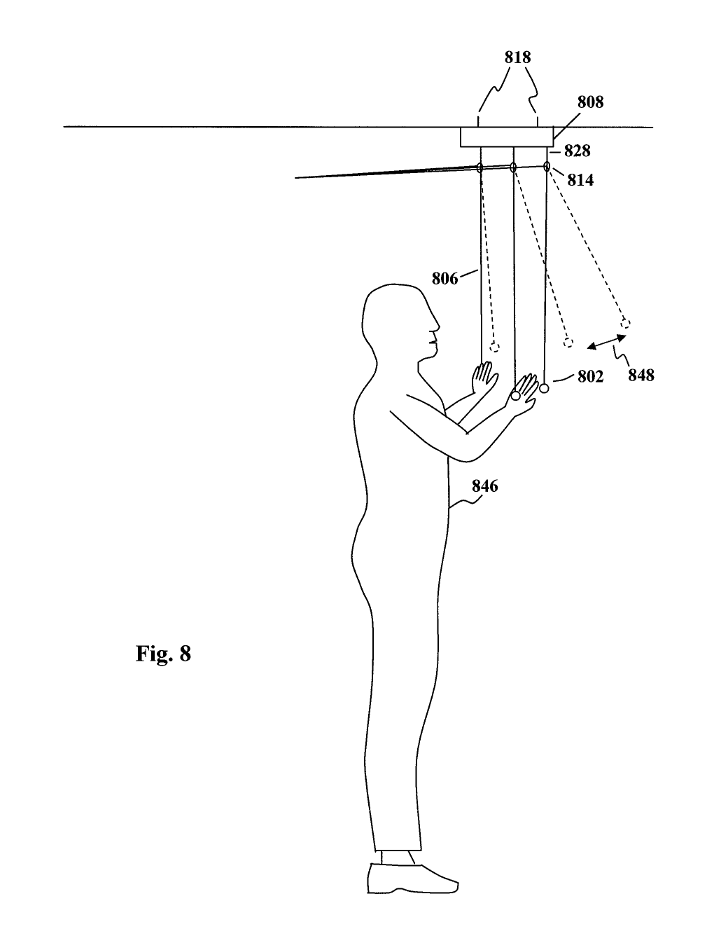

FIG. 8 is a schematic illustration of a side view of an adjustable eyelet channel embodiment of a multiple target physical enhancer exercise apparatus with a ceiling mount and without a height adjustment tether. A user 846 stands beneath the exercise apparatus and interacts with the target objects 802. The target objects move and oscillate 848 in response to the actions of the user 846. The target objects 802 are attached to the horizontal member 808 by tethers 806 which are guided by eyelets 814. Eyelets 814 are connected and held in place on the horizontal member 808 by eyelet extension 828 connected to a mass placed in a pocket in an eyelet channel on the horizontal member 808. The exercise apparatus is mounted on the ceiling via screws 818.

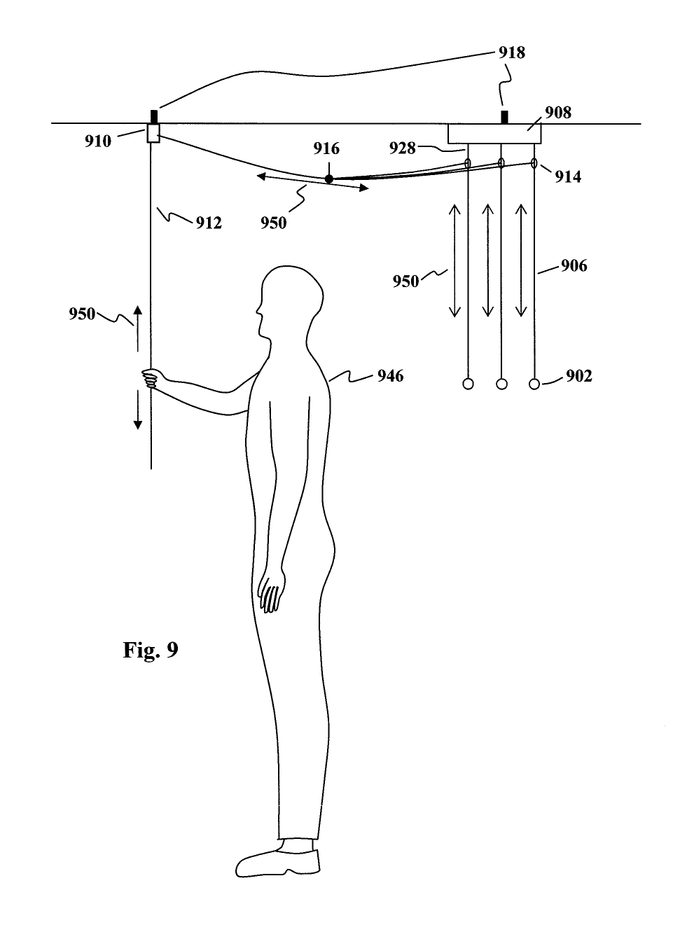

FIG. 9 is a schematic illustration of a side view of an adjustable eyelet channel embodiment of a multiple target physical enhancer exercise apparatus with a ceiling mount and a user 946 adjusting 950 the height of the target objects 902. A user 946 stands beneath the exercise apparatus and faces away from the target objects 902 to interact with the height adjustment tether 912. When the user 946 pulls down on the height adjustment tether the target objects 902 adjust up 950 in height. When the user 946 permits the height adjustment tether 912 to go up, the target objects 902 are adjusted 950 down in height. The target objects 902 are attached to the horizontal member 908 by tethers 906 which are guided by eyelets 914. Eyelets 914 are connected and held in place on the horizontal member 908 by eyelet extension 928 connected to a mass placed in a pocket in an eyelet channel on the horizontal member 908. The tethers 906 are conjoined at a first tether regulator (e.g., a knot) 916. A second tether regulator 910 directs the height adjustment tether 912 from the first 916 and second 910 tether regulators down for easy use by the user 946. The exercise apparatus is mounted on the ceiling via screws 918.

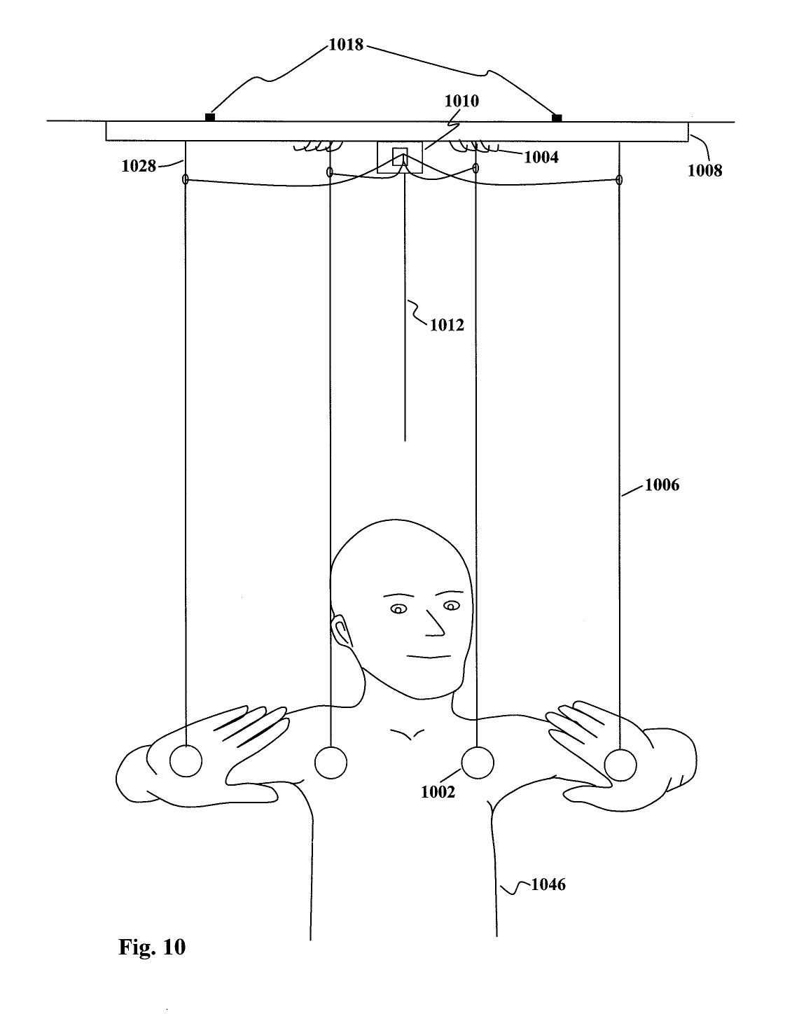

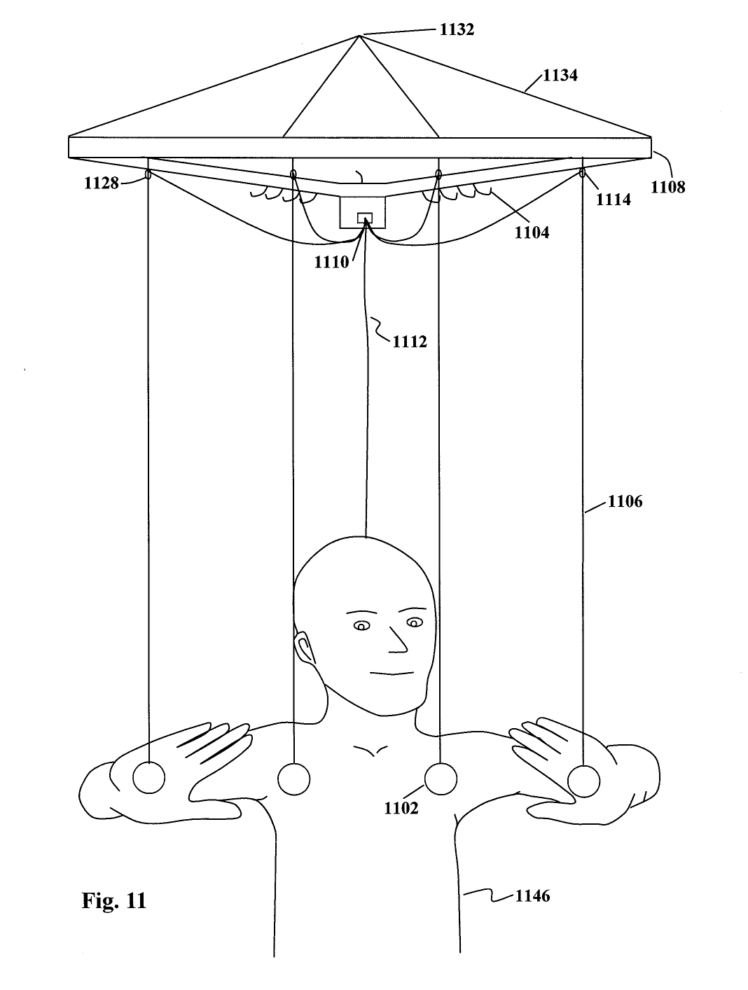

FIG. 10 is a schematic illustration of a front view of an adjustable eyelet channel embodiment of a multiple target physical enhancer exercise apparatus with a wall mount. A user 1046 stands beneath the exercise apparatus and prepares to interact with the target objects 1002. The target objects 1002 are attached to the horizontal member 1008 by tethers 1006 which are guided by eyelets 1014. Eyelets 1014 are connected and held in place on the horizontal member 1008 by eyelet extension 1028 connected to a mass placed in a pocket in an eyelet channel on the horizontal member 1008. The tethers 1006 are conjoined at a first tether regulator (not visible). A second tether regulator 1010 directs the height adjustment tether 1012 from the first and second 1010 tether regulators down for easy use by the user 1046. When not in use, the target objects 1002 may be stored using retainer clips 1004. The exercise apparatus is mounted on the ceiling via screws 1018.

FIG. 11 is a schematic illustration of a front view of an adjustable eyelet channel embodiment of a multiple target physical enhancer exercise apparatus with a wall mount. A user 1146 stands beneath the exercise apparatus and prepares to interact with the target objects 1102. The target objects 1102 are attached to the horizontal member 1108 by tethers 1106 which are guided by eyelets 1114. Eyelets 1114 are connected and held in place on the horizontal member 1108 by eyelet extension 1128 connected to a mass placed in a pocket in an eyelet channel on the horizontal member 1108. The tethers 1106 are conjoined at a first tether regulator (not shown). A second tether regulator 1110 directs the height adjustment tether 1112 from the first and second 1110 tether regulators down for easy use by the user 1146. When not in use, the target objects 1102 may be stored using retainer clips 1104. The exercise apparatus is mounted on the wall via a wall bracket and additional support of wall suspension members 1134 connected to the wall at 1132.

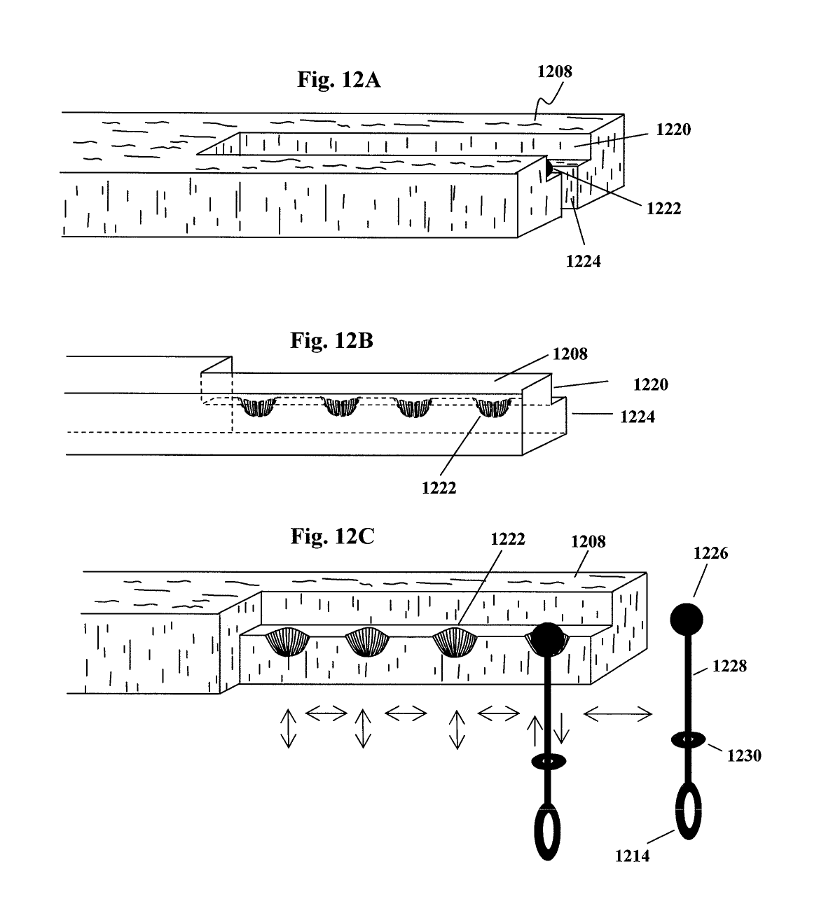

FIGS. 12A-C are a blowup perspective views of an eyelet channel (FIG. 12A), a sectional view of the near half of the eyelet channel (FIG. 12B), and sectional view of the far half of an eyelet channel (FIG. 12C) of an adjustable eyelet channel embodiment of a multiple target physical enhancer exercise apparatus. The eyelet channel 1220 is a channel cut into the horizontal member 1208 for holding guiding eyelets 1214 that may be moved and adjusted by a user. A slot 1224 that goes through the horizontal member 1208 is cut into the eyelet channel 1220 down the center of the eyelet channel 1220. The slot 1224 permits the eyelet extension 1228 to pass through the horizontal member 1208 while the mass 1226 attached to the opposite end of the eye extension 1228 as the eyelet 1214 is too large to pass through the slot 1224 and instead rests in one of the pockets 1222 in the eyelet channel 1220. The eyelet 1214 may be further manipulated with via the eyelet washer 1230. The eyelet channel 1220, slot 1224, pockets 1222, mass 1226 and eyelet extension 1228 permit the eyelet 1214 to be manually adjusted to several different positions with little work required of a user.

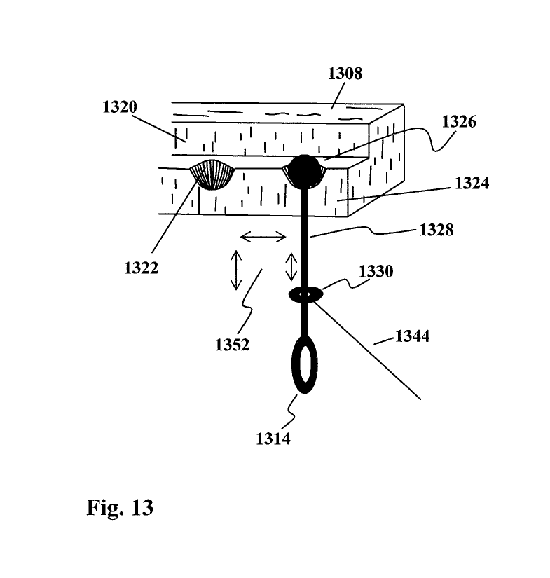

FIG. 13 is a blowup perspective sectional view of the far half of an eyelet channel of an adjustable eyelet channel embodiment of a multiple target physical enhancer exercise apparatus being adjusted with an adjustment tool 1344. The eyelet channel 1320 is a channel cut into the horizontal member 1308 for holding guiding eyelets 1314 that may be moved and adjusted by a user 1352. A tool 1344 may be used to assist the user in adjusting 1352 the location of an eyelet 1314. The tool may catch under the eyelet washer 1330 and lift the eyelet 1314, eyelet extension 1328 and mass 1326 in order to move the eyelet 1314 to hang down from a different pocket 1322. A slot 1324 that goes through the horizontal member 1308 is cut into the eyelet channel 1320 down the center of the eyelet channel 1320. The slot 1324 permits the eyelet extension 1328 to pass through the horizontal member 1308 while the mass 1326 attached to the opposite end of the eye extension 1328 as the eyelet 1314 is too large to pass through the slot 1324 and instead rests in one of the pockets 1322 in the eyelet channel 1320. The eyelet 1314 may be further manipulated with via the eyelet washer 1330 and the adjustment tool 1344.

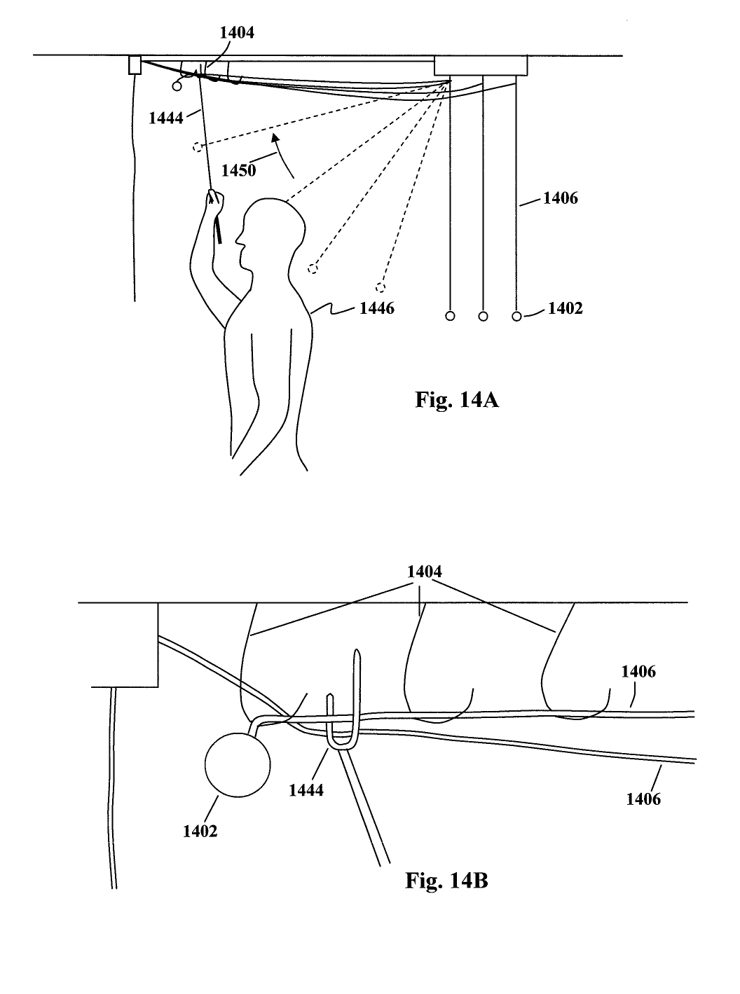

FIG. 14A is an illustration of a user 1446 using a tool 1444 to place a target object 1402 on a retaining clip 1404 for storage. FIG. 14B is a blown up illustration of using a tool 1444 to place a target object 1402 on a retaining clip 1404 for storage. In the embodiment shown in FIGS. 14A & B, a user 1446 may store target objects 1402 by hooking the tether 1406 attached to a target object 1402 and lifting 1450 the tether 1406 and target object 1402 up to the retaining clips 1404. The user 1446 may manipulate the tool 1444 to ensure the tether 1410 and target object 1412 are properly placed in the retainer clips 1404

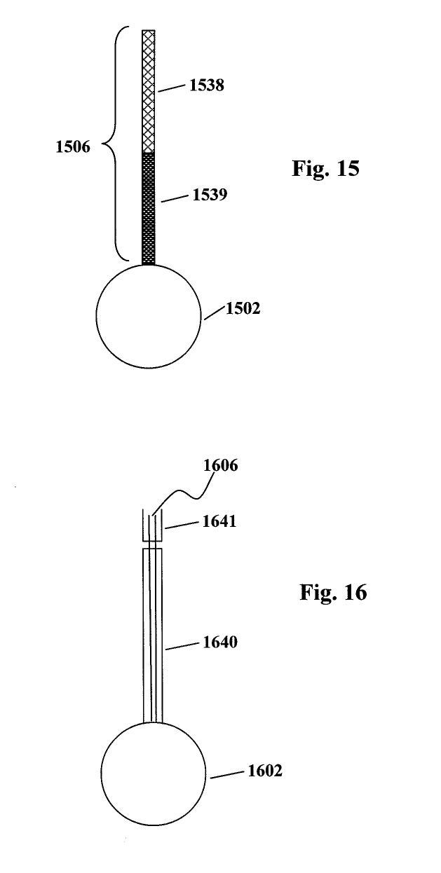

FIG. 15 is a schematic illustration of varying materials 1538, 1539 for the tether 1506. To avoid tangling and twisting, the tether 1506 may be comprised of multiple materials. For instance, the material 1538 in the tether 1506 may be a normal cord material, but the material closer to the target object 1502 may be a rod made of stiffer material such as wood, metal or hard plastic. By making the last segment 1539 of stiffer material, it is difficult for the tethers 1506 to wrap tightly around another target object 1502.

FIG. 16 is a schematic illustration of covering the tether 1606 with a segmented tubing material 1640, 1641. The tubing material encasing the tether 1606 may also be referred to as a sleeve or segmented sleeve 1640, 1641. To help avoid twisting and tangling of the tethers 1606 a tubing sleeve 1640, 1641 may be placed around the tethers 1606. To help avoid twisting and tangling it is preferable that the tubing sleeve for segments 1640, 1641 be made of a stiff material such as a stiff plastic. The tubing material for segments 1640, 1641 may have some flexibility, but it is desirable that the tubing sleeve 1640, 1641 is less flexible than the tether 1606 the sleeve 1640, 1641 is encasing. Some embodiments may cover the entire tether 1606 with segmented sleeves 1640, 1641, while others may only cover a portion of the tether 1606 or simple include a single segment 1640 that will rest near the target object 1606 and act in a similar fashion as the varying material 1539 as discussed in the disclosure with respect to FIG. 15. The segments 1640, 1641 should be small enough that the tether 1606 is still permitted to move with reasonable fluidity to perform the exercises.

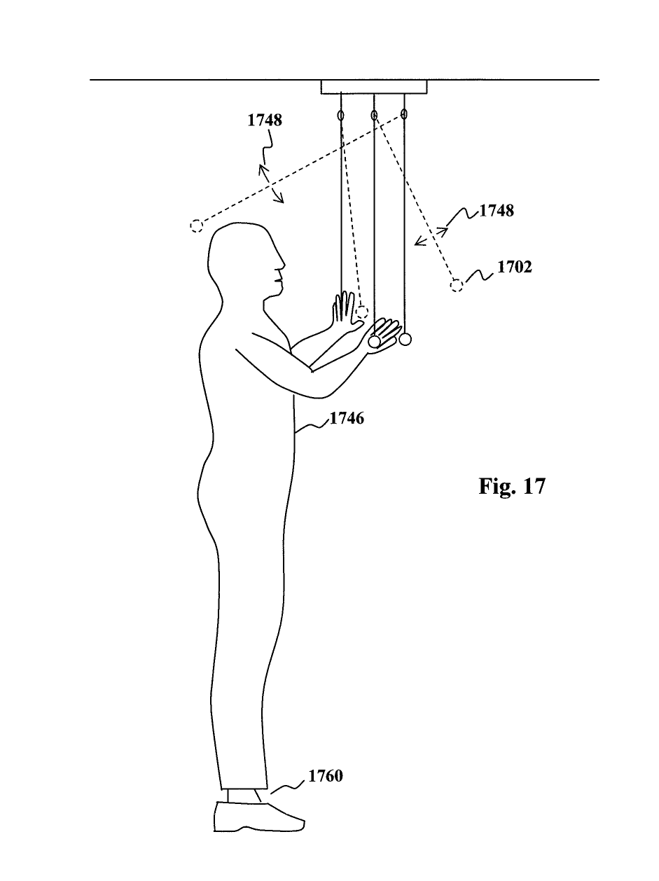

FIG. 17 is an illustration of a user 1746 performing exercises while standing on both legs 1760. As discussed in the disclosure with respect to FIG. 1, a user 1746 may utilize the exercise apparatus from a variety of body stances. In FIG. 17, the user 1746 has multiple target objects 1702 in motion 1748 while standing on both legs 1760.

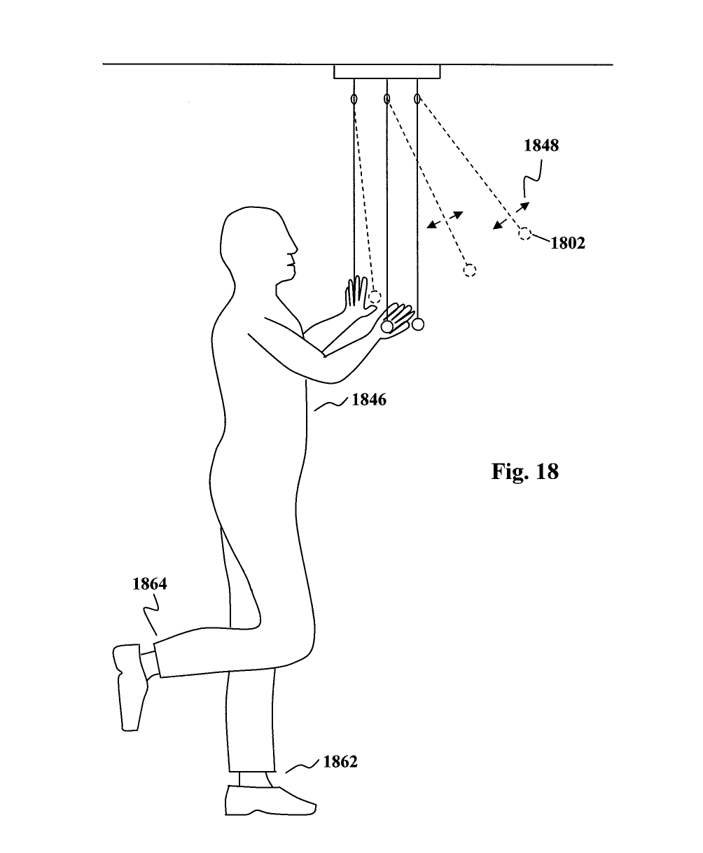

FIG. 18 is an illustration of a user 1846 performing exercises while standing on one leg 1862. In FIG. 18, the user 1846 has multiple target objects 1802 in motion 1848 while standing on one leg 1962. The user 1846 lifts the other leg, unused leg 1864 in the air during the exercise to make the exercise more difficult to perform, and, accordingly more beneficial to the improvement of a user's 1846 physical abilities.

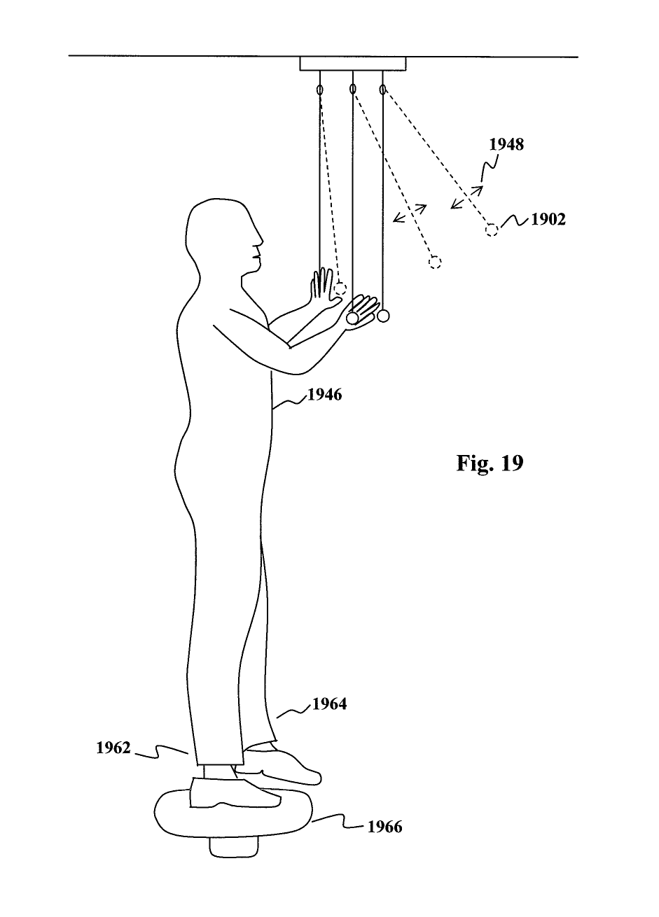

FIG. 19 is an illustration of a user 1946 performing exercises while standing on one leg 1962 and standing on a balance board 1966. In FIG. 19, the user 1946 has multiple target objects 1902 in motion 1948 while standing on one leg 1962 and also standing on a balance board 1966. On the balance board 1966, the user 1946 lifts the other leg, unused leg 1964 in the air during the exercise to make the exercise more difficult to perform, and, accordingly more beneficial to the improvement of a user's 1946 physical abilities. The added dimension of the balance board 1966 makes the exercise even that much more difficult to perform and beneficial to the user 1946.

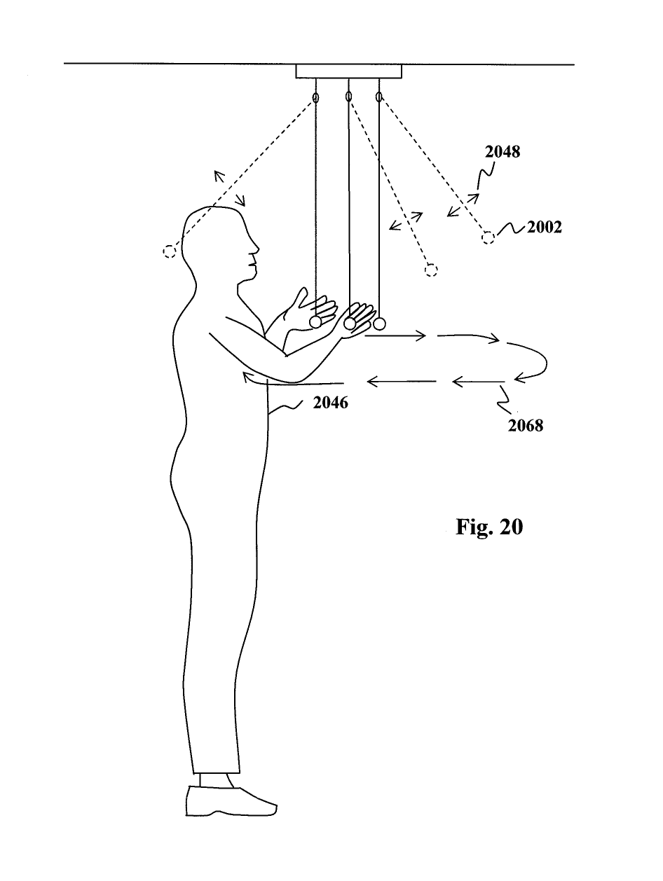

FIG. 20 is an illustration of a user 2046 performing exercises while moving in a circular motion 2068 around the target objects 2002. In FIG. 20, the user 2046 has multiple target objects 2002 in motion 2048. While the target objects 2002 are in motion 2048, the user 2046 circles around 2068 the target objects 2002 to add extra difficulty to the exercise and, accordingly, to better improve the user's 2046 physical abilities. The user 2046 may circle 2068 clockwise and/or counter-clockwise as desired.

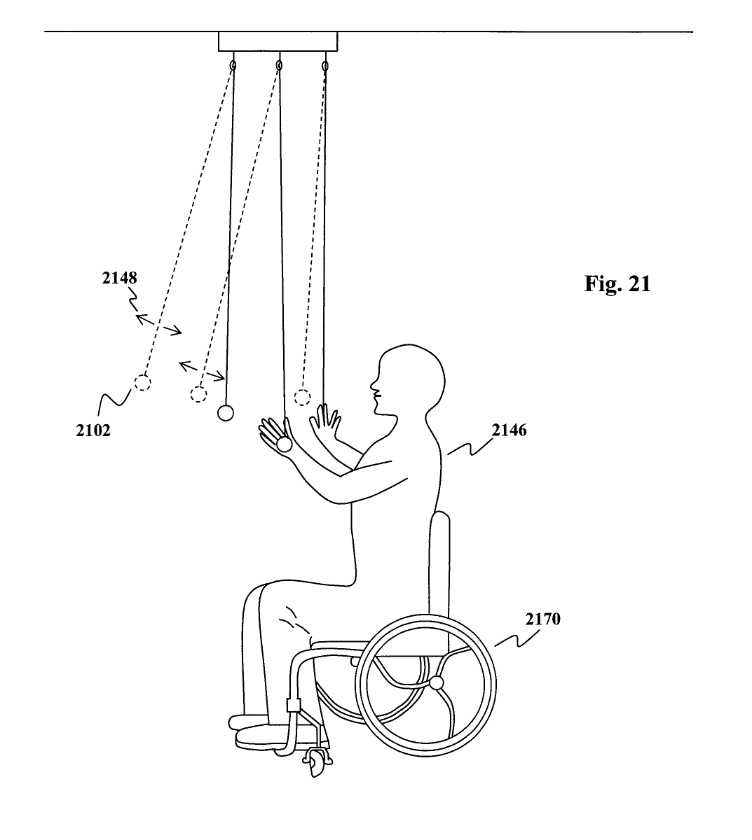

FIG. 21 is an illustration of a user 2146 performing exercises while sitting in a wheel chair 2170. In FIG. 21, the user 2146 has multiple target objects 2102 in motion 2148 while sitting in a wheelchair 2170. While both disabled and non-disabled users 2146 may perform the exercise while sitting, it may be especially beneficial to a user 2146 confined to a wheel chair 2170 to have the ability to continue to develop and improve hand-eye and body coordination including involvement of peripheral vision from a wheelchair 2170.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method for using an exercise apparatus, said exercise apparatus comprising a horizontal member placed parallel to a floor, above a user, and having a plurality of target objects tethered to said horizontal member via a tether with said plurality of target objects hanging down from said horizontal member and spaced along said horizontal member to permit each of said plurality of target objects to swing independently from a remainder of said plurality of target objects, said method comprising:
placing a user within a proximity of said exercise apparatus such that said plurality of target objects, when set in motion, are within range of said tether of hitting said user unless said user hits or avoids said plurality of targets;
setting at least a first target object of said plurality of targets into motion;
keeping said at least first target object in motion by said user;
setting at least a second target object of said plurality of targets into motion while said at least first target is in motion; and
concurrently keeping said at least first target object and said at least second target object in motion by said user, such that said user keeping said at least first target object and said at least second target object in motion is intended to improve coordination and/or peripheral vision of said user.

2. The method for using said exercise apparatus of claim 1 further comprising keeping said at least first target object and said at least second target object from hitting each other by said user.

3. The method for using said exercise apparatus of claim 2 wherein said user keeps said at least first target object and said at least second target object in motion and from hitting each other by hitting said at least first target object and said at least second target object with a part of the user's body.

4. The method for using said exercise apparatus of claim 1 wherein said movement of at least one of said plurality of target objects is tracked via peripheral vision of said user.

5. The method for using said exercise apparatus of claim 1 further comprising adjusting height of said plurality of target objects such that at said least first target object is at a different height than said at least second target object.

6. The method for using said exercise apparatus of claim 1 further comprising moving said user's body to avoid contact with said at least first target object and said at least second target object.

7. The method for using said exercise apparatus of claim 1 further comprising keeping said user in a stationary position while said at least first target object and said at least second target object are moving.

8. The method for using said exercise apparatus of claim 1 further comprising said user moving in a circular movement around said plurality of target objects while said at least first target object and said at least second target object are moving.

9. The method for using said exercise apparatus of claim 1 wherein said setting of a target object of said plurality of target objects in motion is achieved by at least one of the group comprising: said user hits a target object; said user raises and releases a target object; said user throws a target object, a third party causes a target object to moved, and a mechanical device is used to cause a target object to move.

10. The method for using said exercise apparatus of claim 1 wherein said user maintains location in proximity to said plurality of target objects using at least one of the group comprising: standing, standing on one leg, sitting, sitting in a wheelchair, standing on a balance board, standing on one leg on a balance board, sitting on a Bosu Ball, sitting on an inflatable ball, standing with legs bent in a sitting position, standing on an unstable surface, standing on one leg on an unstable surface, and laying down.
